(19) United States
(12) Patent Application Publication
(10) Pub. No.: US 2017/0083850 A1
(43) Pub. Date: Mar. 23, 2017

(54) SYSTEMS AND METHODS FOR CASHIER SCHEDULING

(71) Applicant: Wal-Mart Stores, Inc., Bentonville, AR (US)

(72) Inventors: Bruce Crow, Bentonville, AR (US); Richard Ulrich, Bentonville, AR (US)

(73) Assignee: Wal-Mart Stores, Inc., Bentonville, AR (US)

(21) Appl. No.: 15/310,534

(22) PCT Filed: May 12, 2015
(86) PCT No.: PCT/US15/30353

§ 371 Date: Nov. 11, 2016

Related U.S. Application Data
(60) Provisional application No. 61/992,627, filed on May 13, 2014.

(51) Int. Cl. G06Q 10/06; G06Q 20/20; G06F 17/30

(52) U.S. Cl. CPC G06Q 10/063116; G06F 17/30551; G06Q 20/202; G06Q 10/063118

(57) ABSTRACT

Exemplary embodiments are generally directed to cashier scheduling for a store based on electronic data representative of transactions at a point-of-sale terminal in the store. Exemplary embodiments can compare the electronic data representative of transactions at the point-of-sale terminal to target point-of-sale terminal data for the point-of-sale terminal in the store to generate delta values. Exemplary embodiments can determine exception data based on the delta values. The exception data can correspond to the delta values that fail to satisfy a specified criteria. Exemplary embodiments can adjust scheduling parameters for a prospective scheduling period based on the exception data.

### CROSS-REFERENCE TO RELATED APPLICATIONS

The present application claims the benefit of U.S. provisional patent application entitled “Systems and Methods For Cashier Scheduling” which was filed on May 13, 2014, and assigned Ser. No. 61/992,627. The entire content of the foregoing provisional patent application is incorporated herein by reference.

### TECHNICAL FIELD

The present disclosure relates to systems and methods for scheduling staff and, in particular, to systems and methods for scheduling staff based on a forecast that is generated using exception data associated with past staffing conditions.

### BACKGROUND

An entity operating stores may wish to determine how many staff trained to operate point-of-sale (POS) terminals (e.g., cashiers) should be scheduled (or how many POS terminals should be operating) during a prospective scheduling period to ensure that the stores are appropriately staffed. The task of scheduling staff for one or more stores can become increasingly difficult as the number and size of stores increases. Conventional scheduling algorithms can be dependent on how well a store or the staff at the store execute their tasks (e.g., store execution). For example, poor store execution can adversely affect the forecasting accuracy of conventional scheduling algorithms, such as conventional scheduling algorithms that use electronic data associated with customer arrival rate at POS terminals arrival without accounting for poor store execution that results in extended times between customer arrival at the POS terminal, thereby masking true customer arrival rates. Some conventional scheduling systems may attempt to compensate for this dependency on store execution by increasing the number of cashiers scheduled at all times. However, simply increasing the number of cashiers scheduled at all times can greatly increase operational costs for an entity and can create waste during times of overstaffing. The lack of accuracy in determining the demand for staff and, particularly, staff trained to operate POS terminals (e.g., cashiers) can make it difficult to accurately forecast and adjust staff scheduling for one or more stores to ensure appropriate staffing during a prospective scheduling period.

### SUMMARY

Exemplary embodiments of the present disclosure overcome the disadvantages of conventional scheduling systems by providing for a scheduling system that reduces, minimizes, or eliminates the dependency of the scheduling algorithms on how well a store or the staff at the store execute their tasks (e.g., store execution). Exemplary embodiments of the present disclosure can accurately forecast and adjust staff scheduling for a prospective scheduling period to ensure appropriate staffing based on historic periods of overstaffing or understaffing of staff during previous day and time segments.

In accordance with embodiments of the present disclosure, a computer-implemented method of cashier scheduling for a store is disclosed. The method includes executing code to query a database for electronic data representative of transactions at a point-of-sale (POS) terminal in a store during a period of time. The method includes programmatically comparing the electronic data representative of transactions at the POS terminal to target POS terminal data for the POS terminal in the store. This comparison can generate delta values corresponding to deviations from the target POS terminal data. The method also includes programmatically determining exception data based on the delta values. The exception data can correspond to the delta values that fail to satisfy a specified criteria. The method further includes executing code to adjust scheduling parameters for a prospective scheduling period based on the exception data.

In some embodiments, the electronic data representative of transactions at the POS terminal can be determined by a queue theory algorithm. In some embodiments, the electronic data representative of transactions at the POS terminal can be historical data, e.g., electronic data for a previous time period of six weeks. In some embodiments, the historical data can be electronic data for any period of time or a period of time specified by a user, a scheduling system, or both.

In some embodiments, the electronic data representative of transactions at the POS terminal includes electronic data regarding an actual number of open registers in the store during the specified time period. In some embodiments, the target POS terminal data for the POS terminal includes electronic data regarding a target number of open registers in the store during the specified time period. Programmatically comparing the electronic data representative of transactions at the POS terminal to the target POS terminal data for the POS terminal in the store to generate the delta values can include subtracting electronic data representing a target number of open registers from electronic data representing an actual number of open registers.

In some embodiments, the method includes grouping the delta values by, e.g., store, day, time segment, combinations thereof, and the like. In some embodiments, the time segment can be an approximately fifteen minute time segment. In some embodiments, the method includes determining whether the delta values are positive or negative. The specified criteria can include a predetermined value corresponding to a negative delta value threshold for a predetermined number of at least one of day segments or time segments. In some embodiments, the method includes adjusting the exception data to account for transaction variables. In some embodiments, the method includes excluding a desired time segment from the time period.

In accordance with embodiments of the present disclosure, exemplary non-transitory computer-readable medium storing computer-readable instructions are provided. Execution of the instructions by a processing device causes the processing device to implement a method of cashier scheduling for a store that includes executing code to query a database for electronic data representative of transactions at a POS terminal in a store during a period of time. The method implemented upon execution of the instructions includes programmatically comparing the electronic data representative of transactions at the POS terminal to target POS terminal data for the POS terminal in the store to generate delta values. The method implemented upon execution of the instructions also includes programmatically determining exception data based on the delta values. The exception data corresponds to the delta values that fail to satisfy a specified criteria. The method implemented upon execution of the instructions further includes executing code to adjust scheduling parameters for a prospective scheduling period based on the execution data.

In some embodiments, execution of the instructions by the processing device can cause the processing device to group the delta values by, e.g., store, day, time segment, combinations thereof, and the like.

In accordance with embodiments of the present disclosure, exemplary scheduling systems for scheduling cashiers in a store are provided. A computer storage device of the scheduling systems stores electronic data representative of transactions at a POS terminal in a store. A processing device of the scheduling system can be programmable to execute code to query the computer storage device for the electronic data representative of transactions at the POS terminal in the store during a period of time. The processing device can be programmable to programmatically compare the electronic data representative of transactions at the POS terminal to target POS terminal data for the POS terminal in the store to generate delta values. The processing device can also be programmable to programmatically determine exception data based on the delta values. The exception data can correspond to the delta values that fail to satisfy a specified criteria. The processing device can further be programmable to execute code to adjust scheduling parameters for a prospective scheduling period based on the exception data.

In some embodiments, the electronic data representative of transactions at the POS terminal can be determined by a queue theory algorithm. In some embodiments, the electronic data representative of transactions at the POS terminal includes electronic data regarding an actual number of open registers. In some embodiments, the target POS terminal data for the POS terminal includes electronic data regarding a target number of open registers.

In some embodiments, the processing device can be programmable to programmatically compare the electronic data representative of transactions at the POS terminal to the target POS terminal data for the POS terminal in the store to generate the delta values by subtracting electronic data regarding a target number of open registers from the electronic data regarding an actual number of open registers. In some embodiments, the processing device can be programmable to group the delta values by, e.g., store, day, time segments, combinations thereof, and the like. In some embodiments, the processing device can be programmable to adjust the exception data to account for transaction variables.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the disclosed systems and associated methods, reference is made to the accompanying figures, wherein:

FIG. 1 is a block diagram of an exemplary cashier scheduling system according to the present disclosure;

FIG. 2 is a block diagram of an exemplary register data collector of a cashier scheduling system according to the present disclosure;

FIG. 3 is a block diagram of an exemplary target register calculation engine of a cashier scheduling system according to the present disclosure;

FIG. 4 is a block diagram of an exemplary scheduling forecast calculation engine of a cashier scheduling system according to the present disclosure;

FIG. 5 is a block diagram of an exemplary computing device configured to implement embodiments of an exemplary cashier scheduling system according to the present disclosure;

FIG. 6 is a distributed client-server environment for implementing embodiments of an exemplary cashier scheduling system according to the present disclosure;

FIG. 7 is an exemplary graphical user interface window of an exemplary cashier scheduling system according to the present disclosure;

FIG. 8 is an exemplary graphical user interface window of an exemplary cashier scheduling system according to the present disclosure;

FIG. 9 is an exemplary graphical user interface window of an exemplary cashier scheduling system according to the present disclosure; and

FIG. 10 is a flowchart illustrating implementation of an exemplary cashier scheduling system according to the present disclosure.

### DETAILED DESCRIPTION

Exemplary embodiments of the present disclosure provide for a scheduling system that can be used to accurately forecast and adjust cashier scheduling for a prospective scheduling period to ensure appropriate staffing in a store. The scheduling system can be utilized to determine periods of overstaffing or understaffing of cashiers during a previous time segment and, based on this electronic data, appropriately adjust a future forecast of cashier scheduling for similar time segments. Exemplary embodiments of the scheduling system can advantageously provide a common scheduling platform that can accurately forecast cashier scheduling for one or more stores. As one example, exemplary embodiments of the present disclosure facilitate identifying understaffed periods of time at one or more POS terminals in a store based on a user specified criteria, such as four consecutive understaffed fifteen minute time segments or four consecutive days of understaffed time segments, to forecast and adjust cashier scheduling for similar prospective scheduling periods to ensure appropriate staffing in the store. As another example, exemplary embodiments of the present disclosure facilitate accurately forecasting future customer arrivals by store, day and time segment to forecast and adjust cashier scheduling for prospective scheduling periods to ensure appropriate staffing the store. Understaffing and, thereby, long queue lengths, can be reduced or eliminated.

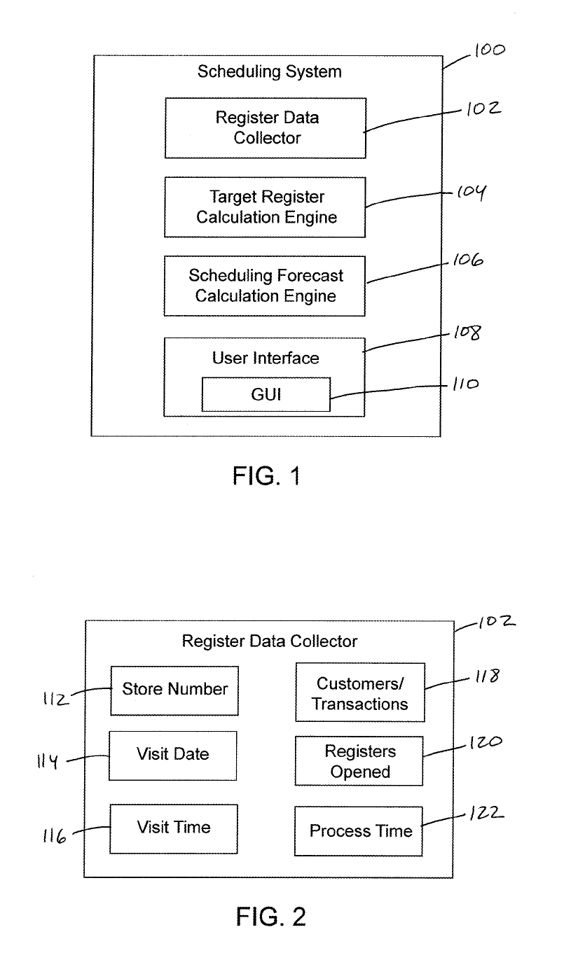

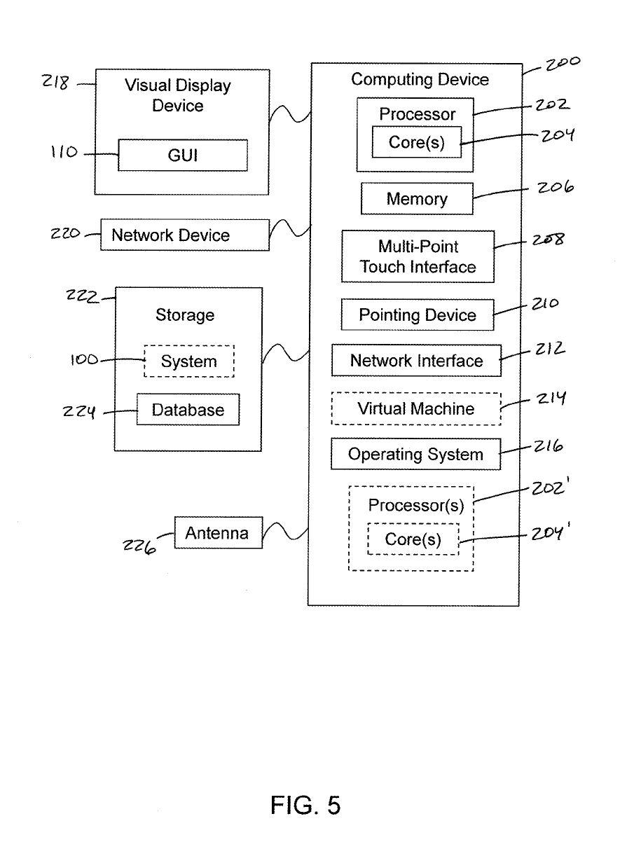

FIG. 1 is a block diagram of an exemplary staff scheduling system 100 (hereinafter “system 100”) that can be implemented using hardware, software, and/or a combination thereof. For example, in one exemplary embodiment, one or more computing devices can be programmed and/or configured to implement exemplary embodiments of the system 100. An exemplary embodiment of a computing device configured to implement embodiments of the system 100, or portions thereof, is depicted, for example, in FIG. 5. The system 100 can include a register data collector 102 (hereinafter “collector 102”), a target register calculation engine 104 (hereinafter “engine 104”), and a scheduling forecast calculation engine 106 (hereinafter “engine 106”).

In some embodiments, the system 100 can include a user interface 108. The user interface 108 can be programmed and/or can include executable code to provide at least one graphical user interface 110 (hereinafter “GUI 110”) through which a user can interact with the system 100. The GUI 110 can be rendered on a display and can include data entry areas to receive information from a user and/or can include data outputs to display information to the user. For example, as described herein, one example GUI 110 can allow a user to enter data representative of POS terminal transactions, specified criteria, scheduling parameters, combinations thereof, and the like, into the system 100, while another example GUI 110 can display POS transaction data, delta values, exception data, specified criteria, scheduling parameters, combinations thereof, and the like to the user. Some examples of data entry fields include, but are not limited to, text boxes, check boxes, buttons, dropdown menus and/or any other suitable data entry fields.

In exemplary embodiments, the system 100 can be programmed and/or configured to accurately forecast and adjust scheduling parameters for scheduling staff for a prospective scheduling period in one or more stores based on POS terminal transactions for a previous time period. The system 100 can, for example, schedule staff that have been trained or authorized to use point-of-sale (POS) terminals in a store (e.g., cashiers) or staff that provide services to customers in a store (e.g., service staff). The system 100 can be utilized by an entity (e.g., a retailer, wholesaler, and the like) to determine time periods of understaffing in one or more stores, which can be distributed across several geographic regions (e.g., domestic and/or international stores), to accurately forecast and, if necessary, adjust staff scheduling for similar prospective scheduling periods.

The time periods of understaffing can be determined based on electronic data representative of transactions associated with an operation of POS terminals in the stores (POS terminal information). This POS terminal information can correspond to point-of-sale data (e.g., raw data) collected from the POS terminals at each respective store and can include, for example, transaction times, actual number of registers opened, register utilization performance, estimated queue lengths, estimated queue wait times, basket sizes, and/or any other suitable information related to an operation of the POS terminals.

In some embodiments, an average transaction time algorithm, a queue theory algorithm, a work standards algorithm, a utilization percent, outputs from an external sensor or other hardware measuring device, combinations thereof, and the like, as described herein, can be used to obtain the POS terminal information for a previous period of time and to identify store, day and time combinations that have a high probability of long line lengths. Thus, based on past POS terminal transaction data, the system 100 can react to customer demand, even if management does not, by accurately forecasting and adjusting cashier scheduling for prospective scheduling periods associated with understaffing. For example, based on the past POS terminal transaction data, the system 100 can forecast and adjust cashier scheduling to correct the historical demand for cashiers, thereby ensuring that stores are appropriately staffed for most, if not all, day and time segments.

Using the collected POS terminal information, the system 100 can calculate target POS terminal data, e.g., target POS terminal transactions, for store, day and time segments that can be used to evaluate whether one or more stores are understaffed or overstaffed for previous periods of time. Some examples of target POS terminal data can include, for example, a target number of open registers, target queue lengths, and the like. Using the system 100, time periods of understaffing for one or more stores for day and time segments can be determined by generating delta values based on the collected POS terminal information and the calculated target POS terminal data to accurately forecast and schedule staff (e.g., cashiers, service staff) for similar prospective scheduling periods to ensure the stores are appropriately staffed.

The system 100 can generate delta values based on a comparison of the actual number of open registers relative to the target number of open registers for previous time periods. For example, the delta values can be generated by subtracting the electronic data representing the target number of open registers from electronic data representing the actual number of open registers for each day and time segment. The system 100 can group the generated delta values by store, day and time segments. The delta values can represent understaffing or overstaffing for each time period. For example, in some embodiments, a negative delta value can represent understaffing in the store for the time segment, while a positive delta value can represent overstaffing in the store for the time segment. As an illustrative non-limiting example, if the actual number of open registers is ten for a specified time segment (e.g., 11:00-11:15) on a specified day (e.g., Tuesdays) and the calculated target number of open registers for the specified time segment is fifteen for the specified day, the delta value can be generated as −5 (e.g., 10 actual open registers minus 15 target open registers) which indicates that for the specified time segment of the specified day, the store was understaffed. On the other hand, if the actual number of open registers is ten for a specified time segment for a specified day and the calculated target number of open registers for the specified time segment for the specified day is eight, the delta value can be generated as 2 (e.g., 10 actual open registers minus 8 target open registers) which indicates that for the specified time segment, the store was overstaffed.

The system 100 can use the generated delta values to determine exception data. In some embodiments, the exception data can correspond to the delta values that fail to satisfy a specified criteria. In some embodiments, the exception data can correspond to the delta values that satisfy a specified criteria. For example, the system can be programmed and/or configured to determine the specified criteria and/or a user of the system 100 can input the specified criteria through the GUI 110. In some embodiments, the specified criteria can correspond to a number of time segments or intervals for which the store is understaffed based on an evaluation of the generated delta values. For example, the specified criteria can be represented by instances for which two or more consecutive delta values indicative of an understaffing condition at the store. However, it should be understood that the criteria can be specified to include any number of consecutive delta values, e.g., two, three, four, five, and the like. Thus, if the system 100 determines exception data based on the specified criteria which indicates that the store was understaffed for a number of consecutive time segments, the system 100 can accurately forecast or adjust scheduling parameters, e.g., cashier or service staff schedules, for a prospective scheduling period. In some embodiments, the specified criteria can be represented by two or less consecutive delta values which indicate that the store was understaffed, such that if three consecutive negative delta values exist, the group of delta values will fail to satisfy the specified criteria.

In some embodiments, the prospective scheduling period can correspond to similar day and time segments for which the exception data was determined. For example, if exception data was determined for three consecutive Mondays from 12:00 PM to 1:00 PM (e.g., the store was understaffed on the same day each week during the same time segment for three weeks), the system 100 can adjust the prospective scheduling period for future Mondays from 12:00 PM to 1:00 PM by adding additional staff to the schedule for the day (e.g., Mondays) and time segment (e.g., 12:00 PM to 1:00 PM) to ensure that the store is appropriately staffed. In some embodiments, when forecasting or adjusting scheduling parameters, the system 100 can incorporate or apply a buffer percentage to appropriately increase the forecasted scheduling parameters. For example, the buffer can be applied or incorporated into the forecasted scheduling parameters to account for random events or transaction variables, such as random customer arrival rates, rest and personal needs allowance, fatigue factors, absenteeism rate factors, POS terminal maintenance, and the like.

In some embodiments, the collected POS terminal information and the calculated target POS terminal data can be in specified time intervals (e.g., every fifteen minutes). The target POS terminal data calculated for consecutive time intervals (e.g., fifteen minute intervals) as compared to the collected POS terminal information can be aggregated by the system 100 to reflect periods of understaffing or overstaffing of one or more stores over a selected time period (e.g., one hour). For example, the system 100 can calculate target POS terminal data for an individual store every fifteen minutes and the system 100 can be programmed and/or configured to aggregate the target POS terminal data for four consecutive time intervals to generate target POS terminal data associated with one hour. Similarly, the system 100 can generate delta values based on a comparison of the collected POS terminal information and the calculated target POS terminal data and the system 100 can be programmed and/or configured to aggregate the delta values for, e.g., four consecutive time intervals to generate a period of understaffing associated with one hour. In some embodiments, alternative time intervals can be implemented.

The system 100 can thereby be used to accurately forecast and adjust staff scheduling for one or more stores. The collected POS terminal information can be turned into useful statistics regarding understaffing of one or more stores during previous periods of time. The system 100 can therefore be used to correct understaffed day and time segments in one or more stores by forecasting and adjusting staff scheduling for prospective scheduling periods.

Referring to FIGS. 1 and 2, the collector 102 of the system 100 can receive as input electronic data representative of transactions at a POS terminal (POS transaction data) included in the POS terminal information to determine line length (i.e., queue length) and the actual number of open registers for previous periods of time, e.g., six to ten weeks. The POS terminal information can be collected and generated automatically by the POS terminal as transactions take place at the POS terminal. Thus, the POS transaction data can be historical data collected at the POS terminal for previous periods of time and stored in, e.g., a computer storage or database. As will be discussed in greater detail below, the POS transaction data can be used to analyze past performance for stores based on day and time segments. The POS transaction data can be used to adjust staff scheduling forecasts for customers and items by store, day and time segment prior to demand being generated to create a more accurate staff scheduling forecast to estimate cashier demand and prospectively manage queue length, thereby improving the customer experience. The POS transaction data utilized or received by the collector 102 can include, for example, a store number 112, a visit date 114, a visit time 116, a customers/transactions 118, a registers opened 120, a process time 122, and/or any other suitable POS transaction data. While the POS transaction data discussed herein is illustrative of exemplary POS transaction data, those skilled in the art will recognize that other and/or different POS transaction data can be specified.

The store number 112 can include one or more integer or alphanumeric indicators representative of a particular store in a specific location. The visit date 114 can include the date or day of the week of interest. The visit time 116 can include the time of day of interest. In some embodiments, the visit time 116 can include a visit time determined in fifteen minute intervals. The customers/transactions 118 can include a number of customers or transactions occurring by day and time segment. The registers opened 120 can include an actual number of POS terminals or registers which are opened in a particular store by day and time segment. In some embodiments, the registers opened 120 can be determined by sensing an item scan count as greater than zero at the particular POS terminal. For example, a POS terminal scanning one or more items for a particular day and time segment in a store can represent an open register. On the other hand, a POS terminal scanning zero items for a particular day and time segment in a store can represent a closed register. In some embodiments, item scans or transactions at a POS terminal which are voided or aborted can be excluded from the determination whether the POS terminal was open or closed. In some embodiments, only front end POS terminals can be included in determining the registers opened 120 value. The process time 122 can include a time for processing each customer or transaction at a POS terminal.

The POS transaction data can be utilized as input by collector 102 to determine the actual number of open registers by store, day and time segments. In some embodiments, the POS transaction data can be utilized as input by the collector 102 to determine, e.g., average arrival rates of customers, average service rates of customers, utilization (e.g., a percentage of the time that scans or transactions are occurring at an open POS terminal), time spent in line, average time waiting in line, an average number of customers in the store during day and time segments, and the like, as described in more detail, for example, in U.S. patent application Ser. No. 14/071,914, entitled “Performance Evaluation System For Stores”, the contents of which are incorporated herein by reference in its entirety.

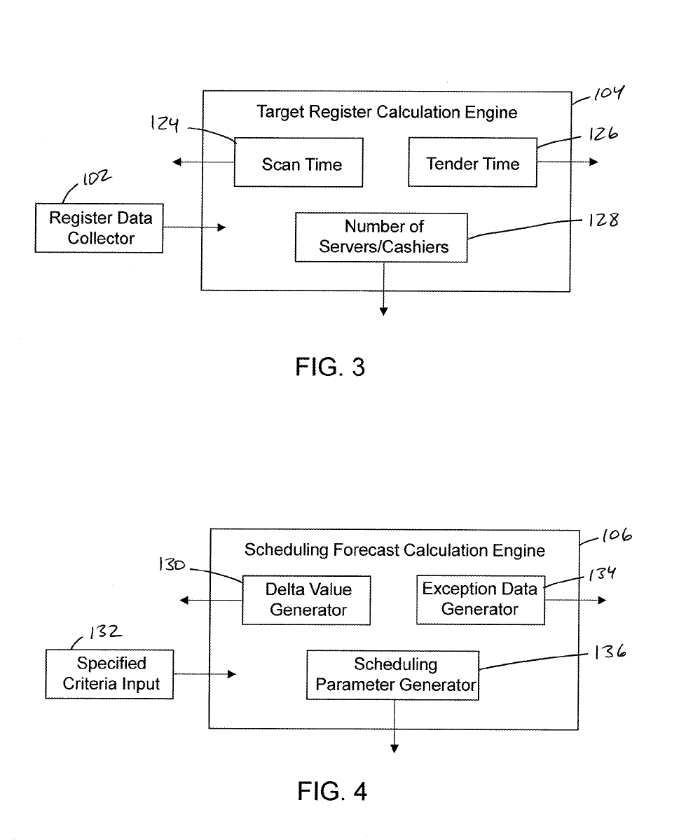

Referring now to FIGS. 1 and 3, the engine 104 of the system 100 can use the POS transaction data input from the collector 102 to determine the number of POS terminals which should have been open by store, day and time segments. In some embodiments, the engine 104 can use any, all, or a combination of the POS transaction data as input from the collector 102. By determining the number of POS terminals that should have been open, a target number of cashiers or service staff that should have been scheduled for the particular store, day and time segment can be determined. In some embodiments, the engine 104 can determine an average scan time 124 and an average tender time 126 by store, day and time segment. The scan time 124 can be the time from the first scanning and/or weighing of an item until a sub-total key on the POS terminal is pressed to indicate an end of scanning. The tender time 126 can be the time from when the sub-total key is pressed until the tender key is pressed. The tender key can be for, e.g., cash, check, credit card, and the like.

In some embodiments, as described herein, an average transaction time algorithm, a queue theory algorithm, a work standards algorithm, combinations thereof, and the like, can be used by the engine 104 to review the POS terminal data for a previous period of time to identify store, day and time combinations that have a high probability of long line lengths. However, it should be understood that the system 100 can be utilized with alternative scheduling algorithms. In particular, algorithms can be used to assist in forecasting cashier demand in the future by analyzing past transactions and determining what should have happened in the past, e.g., an actual number of open registers and a target number of open registers, which, for example, correlates to the number of cashiers that should have been scheduled. In some embodiments, algorithms can use historical data to enable a forecast of cashier workload for a forecasted period of time in the future. Thus, the algorithms can be constrained by data regarding past performance. In some embodiments, an additional analysis to the outcome of the historical data can be performed to correct or improve the past history before the cashier or staff schedule is created for a prospective period of time to ensure that stores are appropriately staffed. For example, the average transaction time algorithm can be calculated by Equation 1:

$$Cashiers = \frac{( ( AST \times UCF ) + ( ATT \times TCF ) ) \times Buffer}{900 seconds} \qquad ( 1 )$$

where Cashiers is the target number of cashiers or POS terminals which should have been open, AST is an average scan time per unit or item in seconds, UCF is a unit count forecast, ATT is an average tender time in seconds, TCF is a transaction count forecast, and Buffer is a percentage applied or incorporated into the forecasted target number of cashiers to account for random events or transaction variables, such as random customer arrival rates, rest and personal needs allowance, fatigue factors, absenteeism rate factors, POS terminal maintenance, and the like. Equation 1 can thereby provide the target number of cashiers which should have been scheduled or POS terminals which should have been open by store, day and time segment for a previous period of time.

As a further example, the queue theory algorithm can be calculated by Equations 2-9:

$$\begin{matrix}{π}_{0} = \frac{1}{{\sum }_{i = 0}^{i = ( s - 1 )} \frac{{( s ρ )}^{i}}{i !} + \frac{{( s ρ )}^{s}}{s ! ( 1 - ρ )}} & ( 2 ) \\ {π}_{j} = \frac{{( s ρ )}^{j} {π}_{0}}{j !} ( j = 1 , 2 … s ) & ( 3 ) \\ {π}_{j} = \frac{{( s ρ )}^{j} {π}_{0}}{s ! {s}^{j - s}} ( j = s , s + 1 , s + 2 … ) & ( 4 ) \\ P ( j \geq s ) = \frac{{( s ρ )}^{s} {π}_{0}}{s ! ( 1 - ρ )} & ( 5 ) \\ {L}_{q} = \frac{P ( j \geq s ) ρ}{( 1 - ρ )} & ( 6 ) \\ {W}_{q} = \frac{{L}_{q}}{λ} = \frac{P ( j \geq s )}{s μ - λ} = {\sum }_{j = s}^{∞} ( j - s ) {π}_{j} & ( 7 ) \\ L = {L}_{q} + \frac{λ}{μ} & ( 8 ) \\ W = \frac{L}{λ} = \frac{{L}_{q}}{λ + \frac{1}{μ}} = {W}_{q} + \frac{1}{μ} = \frac{P ( j \geq s )}{s μ - λ} + \frac{1}{μ} & ( 9 )\end{matrix}$$

where π₀ represents a steady state or equilibrium probability of state 0, πⱼ represents a steady state or equilibrium probability of state j, s represents a number of staff, servers, cashiers, or combinations thereof, ρ represents a utilization of the system, j represents a state of the system, P represents probability, L_{q} represents an expected number of customers waiting in a queue, W_{q} represents an expected amount of time customers wait in a queue, λ represents a customer arrival rate, W represents a total time in the system (e.g., wait time and service time), L represents a total number of customers in the system (e.g., being served and waiting in queue), and μ represents a service rate of cashiers.

In some embodiments, an optimal value for the number of cashiers or POS terminals can be between approximately 70 percent and approximately 80 percent of utilization, e.g., the percentage of time that cashiers or POS terminals are busy serving customers. In some embodiments, based on the POS terminal data, the queue theory algorithm can identify day and time combinations that have a high probability of long line length. Appropriate scheduling adjustments can be made by the system 100 in response to identifying day and time combination that are likely to long line lengths to reduce line lengths in the stores. In some embodiments, based on the POS terminal data, the queue theory algorithm can identify queues with a magnitude of the queue lengths to forecast cashier demand for a prospective period of time. For example, the system 100 can adjust scheduling parameters for the prospective period of time such that queue lengths are maintained below a certain number, e.g., below two or three customers in each line, and the like. In some embodiments, a buffer percentage can be applied or incorporated into the forecasted target number of cashiers to account for random events or transaction variables, such as random customer arrival rates, staff rest periods and personal needs allowance for staff, staff fatigue factors, staff absenteeism rate factors, POS terminal maintenance, and the like. Equations 2-9 can thereby provide the target number of cashiers that should have been scheduled or POS terminals that should have been open by store, day and time segment for a previous period of time based on a target line length for each store, day and time segment (e.g., a target line length of one) using forecasted customers and average transaction times.

As yet a further example, the work standards algorithm can be calculated by Equations 10 and 11:

$$\begin{matrix}Total Time Required = {\sum }_{n = 1}^{n = ∞} Forecast Task n \times Standard Task Time & ( 10 ) \\ Cashier = \frac{Total Time Required}{900 seconds} & ( 11 )\end{matrix}$$

where Forecast Task n is a specific task, Standard Task Time is the reasonable time it takes to perform the specific task, Total Time Required is the total time for all tasks to be performed, and Cashier is the target number of cashiers which should have been scheduled for each time segment. Equation 10 can represent a general formula for cashier time required, while Equation 11 can represent a number of cashiers required during a fifteen minute period. In some embodiments, the total time for all tasks can be calculated in seconds for each day and time segment. In some embodiments, a buffer percentage can be applied or incorporated into the forecasted target number of cashiers to account for random events, such as random customer arrival rates, staff rest periods and personal needs allowance of staff, staff fatigue factors, staff absenteeism rate factors, POS terminal maintenance, and the like. Equations 10 and 11 can thereby provide the target number of cashiers which should have been scheduled or POS terminals which should have been open by store, day and time segment for a previous period of time to perform the necessary tasks.

In some embodiments, an alternative buffer algorithm can be used by the engine 104 to review the POS terminal data for a previous period of time to identify store, day and time combinations that have a high probability of long line lengths. For example, the alternative buffer algorithm can be calculated by Equation 12:

Cashiers=((AST×UCF)+(ATT×CCF)+(DV×((1−Buffer)×900 seconds)))×Buffer (12)

where Cashiers is the target number of cashiers or POS terminals which should have been open, AST is an average scan time per unit or item in seconds, UCF is a unit count forecast, ATT is an average tender time in seconds, CCF is a customer count forecast, DV is a delta value, and Buffer is a percentage applied or incorporated into the forecasted target number of cashiers to account for random events or transaction variables, such as random customer arrival rates, rest and personal needs allowance, fatigue factors, absenteeism rate factors, POS terminal maintenance, and the like.

In some embodiments, the algorithms discussed above can be implemented for calculation of delta values and Equation 12 can be implemented to determine the target number of cashiers which should have been scheduled or POS terminals which should have been open by store, day and time segment by incorporating the calculated delta values into the analysis of Equation 12. Equation 12 can thereby provide the target number of cashiers which should have been scheduled or POS terminals which should have been open by store, day and time segment for a previous period of time. In particular, Equation 12 takes into account the forecast of items and/or customers, in addition to the generated delta value, to determine the target number of cashiers or POS terminals which should be open during a prospective scheduling period. The generated delta value for store, day and time segments of understaffing can therefore be applied to a forecast of cashier demand to generate a new demand curve for cashier scheduling for a prospective period of time.

Referring to FIGS. 1 and 4, the engine 106 of the system 100 can use the data collected or generated by the collector 102 and the engine 104 to determine delta values, determine exception data and adjust scheduling parameters for a prospective scheduling period. In some embodiments, the engine 106 can include a delta value generator 130, a specified criteria input 132, an exception data generator 134, and a scheduling parameter generator 136. In some embodiments, rather than being a separate component of the engine 106, a portion of or the entire scheduling parameter generator 136 can be integrated as part of the engine 106. The delta value generator 130 can generate delta values or factors based on a comparison of the electronic data representative of the POS terminal data relative to the target POS terminal data. In some embodiments, the delta value generator 130 can subtract the target number of open registers determined by the engine 104 from the actual number of open registers determined by the registers opened 120 in the collector 102.

As noted above, the delta values can represent understaffing or overstaffing for each time segment or period. The engine 106 can determine whether the delta values generated by the delta value generator 130 are positive or negative. A negative delta value can represent understaffing in the store for the time segment, while a positive delta value can represent overstaffing in the store for the time segment. For example, if the actual number of open registers is ten for a time segment and the calculated target number of open registers for the time segment is fifteen, the delta value can be generated as −5 (e.g., 10 actual open registers minus 15 target open registers) which indicates that for the time segment, the store was understaffed. On the other hand, if the actual number of open registers is ten for a time segment and the calculated target number of open registers for the time segments is eight, the delta value can be generated as 2 (e.g., 10 actual open registers minus 8 target open registers) which indicates that for the time segment, the store was overstaffed. The delta value generator 130 can generate delta values by store, day and time segment. In some embodiments, the delta value generator 130 can group the delta values by similar store, day and time segment. For example, the delta value generator 130 can group each fifteen minute time segment for every Monday during a previous time period, e.g., six to ten weeks.

The engine 106 can receive a value for the specified criteria input 132 from a user through, for example, the GUI 110. The specified criteria input 132 can have a value that is set by the system (e.g., a default value) that may be changed by the user via the GUI 110. In some embodiments, the specified criteria can be a predetermined value that is a negative delta value threshold for a predetermined number of, e.g., day segments, time segments, combinations thereof, and the like. For example, an entity can designate the specified criteria as any two or more consecutive or recurring negative delta values for a time segment, e.g., two or more consecutive Mondays from 12:00 PM to 12:15 PM having negative delta values. However, it should be understood that the specified criteria can be designated as, e.g., two, three, four, five, six, or more, consecutive or recurring negative delta values for a time segment. In some embodiments, the specified criteria can be designated as consecutive or recurring negative delta values for day segments, e.g., two or more consecutive Mondays having negative delta values, two or more consecutive Mondays for the shift from 2:00 PM to 10:00 PM have negative delta values, and the like.

The exception data generator 134 of the engine 106 can determine exception data by store, day and time segment based on the delta values generated by the delta value generator 130 and the specified criteria of the specified criteria input 132. In some embodiments, the exception data can correspond to the delta values that fail to satisfy a specified criteria. For example, if the specified criteria is input by an entity as three or more consecutive negative delta values for a time segment and the delta values indicate that a store has consecutive negative delta values for Monday from 12:00 PM to 12:15 PM (or any other time segment) for four consecutive weeks, the exception data generator 134 can determine this day and time segment as exception data and can flag this day and time segment for adjustment in prospective cashier scheduling. It should be noted that the specified criteria indicates a frequency in understaffing for a store for a day, time segment, or both. Thus, rather than focusing on single events of understaffing during a previous time period, the system 100 can focus on determining frequently understaffed days, time segments, or both, for a store and appropriately adjust cashier scheduling for prospective scheduling periods. In some embodiments, rather than consecutive negative delta values, the exception data can be based on, for example, three or more negative delta values occurring during one day, which indicate that the store was understaffed during the particular day. In some embodiments, the exception data can be based on time segments which have long queues occur an operationally determined percentage number of times during a specified period of time, e.g., during a multi-week analysis.

In some embodiments, the engine 106 can generate a table with a forecast of cashier scheduling with headings for, e.g., country code, store number, day or date, time segment, delta value, and the like. For example, the engine 106 can generate a table with a forecast of cashier scheduling for a prospective scheduling period of approximately six weeks. In some embodiments, the generated table can be loaded into a scheduling system associated with the system 100.

For all day, time segments, or both, flagged by the exception data generator 134 as having consecutive negative delta values meeting the specified criteria, the scheduling parameter generator 136 of the engine 106 can adjust the scheduling parameters (e.g., cashier or server schedules) for the prospective scheduling period. In particular, the scheduling parameter generator 136 can adjust the cashier or server schedules for a prospective scheduling period prior to generation of the next set of schedules.

For example, if the cashier schedule indicates that five cashiers are scheduled for the understaffed time segment on each Monday from 12:00 PM to 12:15 PM during the prospective scheduling period and the engine 104 determined that seven cashiers should be scheduled or seven POS terminals should be open during this day and time segment (e.g., a delta value of −2), the scheduling parameter generator 136 can adjust the cashier schedule to schedule two additional cashiers to the cashier schedule such that seven cashiers are scheduled for the day and time segment in the future. In some embodiments, the number of additional cashiers to be scheduled can be referred to as an adjustment factor applied to the cashier schedule for the particular day and time segment. As a further example, if the engine 104 determined a delta value of −2 for one Monday during this time segment and a delta value of −4 for a subsequent Monday during this time segment, the scheduling parameter generator 136 can adjust the schedule by averaging and rounding the delta values for the day and time segment to the nearest whole number (e.g., an average equivalent of shortfall in scheduling). Thus, an average of a delta value of −2 and a delta value of −4 can result in an adjustment of three cashiers for the day and time segment during the prospective scheduling period. The cashier schedule for a prospective period of time can therefore be adjusted to meet the demand trend detected from the past historical data.

In some embodiments, the cashier schedule for store, day and time segments with a positive delta value (or a delta value of zero) can remain as previously scheduled for the prospective scheduling period since the positive delta value indicates that the store was appropriately staffed or overstaffed. In some embodiments, the scheduling parameter generator 136 can adjust the cashier schedule for the day or time segment, or both, having consecutive positive delta values to ensure that the store is not overstaffed for the day and time segment. Waste associated with overstaffing in the store can thereby be reduced or eliminated by appropriately adjusting the cashier scheduling for the prospective scheduling period.

In some embodiments, the engine 106 can load the prospective cashier schedule into a table associated with a cashier scheduling system or a data management system (or the system 100) such that the final cashier schedule can be generated. In some embodiments, the cashier scheduling system into which the final cashier schedule or table is output can be, e.g., RedPrairie®. However, it should be understood that alternative cashier scheduling platforms can be implemented. In some embodiments, the system 100 can repeat the steps discussed above to accurately forecast and generate cashier schedules on a recurring basis, e.g., every six weeks, and the like.

It should be understood that the system 100 can review demand trends on an ongoing or real-time basis such that as demand trends change, the system 100 can adjust the scheduling parameters to maintain the store appropriately staffed. Thus, although an increase in the number of cashiers scheduled may be required for one set of cashier schedules, the system 100 can determine at a future time that the subsequent cashier schedules should be adjusted to reduce the number of cashiers during a similar time segment due to a decrease in demand

In some embodiments, the system 100 can be programmed and/or configured to exclude certain time periods from adjustment by the engine 106. For example, holidays are generally defined by customer demand which is different or abnormal as compared to non-holiday time periods. Thus, rather than adjusting scheduling parameters for a prospective scheduling period during a holiday, the system 100 can exclude holidays from adjustment and scheduling for holidays can be determined by an entity based on prior experience of customer demand.

Turning to FIG. 5, a block diagram of an exemplary computing device 200 configured to implement exemplary embodiments of the system 100 is provided. The computing device 200 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 206 included in the computing device 200 may store computer-readable and computer-executable instructions or software for implementing exemplary embodiments of the system 100. The computing device 200 also includes a configurable and/or programmable processor 202 and associated core 204, and optionally, one or more additional configurable and/or programmable processor(s) 202′ and associated core(s) 204′ (for example, in the case of computer systems having multiple processors/cores), for executing computer-readable and computer-executable instructions or software stored in the memory 206 and other programs for controlling system hardware. Processor 202 and processor(s) 202′ may each be a single core processor or multiple core (604 and 604′) processor.

Virtualization may be employed in the computing device 200 so that infrastructure and resourced in the computing device 200 may be shared dynamically. A virtual machine 214 may be provided to handle a process running on multiple processors 202 so that the process appears to be using only one computing resource rather than multiple computing resources. Multiple virtual machines may also be used with one processor 202.

Memory 206 may include a computer system memory or random access memory, such as DRAM, SRAM, EDO RAM, and the like. Memory 206 may include other types of memory as well, or combinations thereof.

A user may interact with the computing device 200 through a visual display device 218, such as a computer monitor, which may display one or more graphical user interfaces 110 that may be provided in accordance with exemplary embodiments. The computing device 200 may include other I/O devices for receiving input from a user, for example, a keyboard 208 or any suitable multi-point touch interface, a pointing device 210 (e.g., a mouse), and the like. The keyboard 208 and the pointing device 210 may be coupled to the visual display device 218. The computing device 200 may include other suitable conventional I/O peripherals.

The computing device 200 may also include one or more storage devices 222, such as a hard-drive, CD-ROM, or other computer-readable media, for storing data and computer-readable instructions and/or software that implement exemplary embodiments of the system 100 described herein. Exemplary storage device 222 may also store one or more databases 224 for storing any suitable information required to implement exemplary embodiments. For example, exemplary storage device 222 can store one or more databases 224 for storing information, such as POS terminal data, target POS terminal data, delta values, specified criteria, exception data, scheduling parameters, prospective schedules, and the like, and values collected, generated or calculated by the collector 102 and the engines 104, 106 to be used by embodiments of the system 100. The databases 224 may be updated manually or automatically at any suitable time to add, delete and/or update one or more items in the databases 224.

The computing device 200 can include a network interface 212 configured to interface via one or more network devices 220 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing device 200 can include one or more antennas 226 to facilitate wireless communication (e.g., via the network interface 212) between the computing device 200 and a network. The network interface 212 may include a built-in network adapter, network interface card, PCMCIA network card, card bus network adapter, wireless network adapter, USB network adapter, modem or any other device suitable for interfacing the computing device 200 to any type of network capable of communication and performing the operations described herein. Moreover, the computing device 200 may be any computer system, such as a workstation, desktop computer, server, laptop, handheld computer, tablet computer (e.g., the iPad™ tablet computer), mobile computing or communication device (e.g., the iPhone™ communication device), point-of-sale terminal, internal corporate devices, or other form of computing or telecommunications device that is capable of communication and that has sufficient processor power and memory capacity to perform the operations described herein.

The computing device 200 may run any operating system 216, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 200 and performing the operations described herein. In exemplary embodiments, the operating system 216 may be run in native mode or emulated mode. In an exemplary embodiment, the operating system 216 may be run on one or more cloud machine instances.

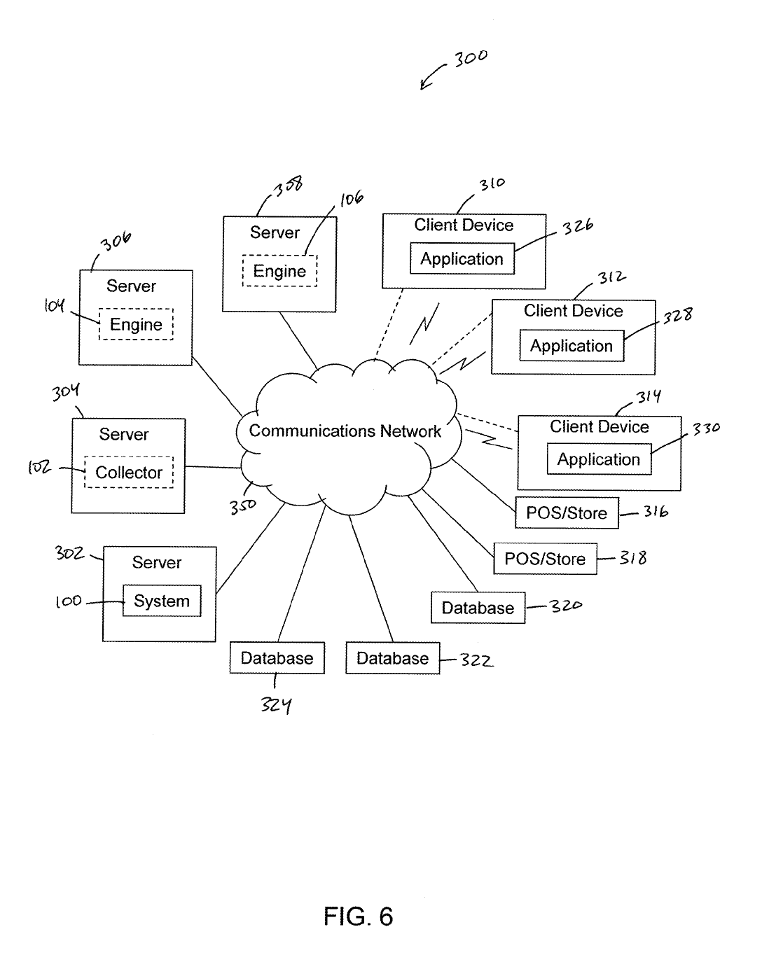

FIG. 6 is a block diagram of an exemplary client-server environment 300 configured to implement one or more embodiments of the system 100. The client-server environment 300 includes servers 302-308 operatively coupled to client devices 310-314 via a communications network 350, which can be any network over which information can be transmitted between devices communicatively coupled to the network. For example, the communications network 350 can be the Internet, an Intranet, a virtual private network (VPN), a wide area network (WAN), a local area network (LAN), and the like. The client-server environment 300 can include repositories or databases 320-324 which can be operatively coupled to the servers 302-308, as well as to client devices 320-324 via the communications network 350. The client-server environment 300 can include point-of-sale terminals or stores 316-318 which can be operatively coupled to the servers 302-308, the client devices 310-314 and the databases 320-324 via the communications network 350. The servers 302-308, client devices 310-314, point-of-sale terminals or stores 316-318, and databases 320-324 can be implemented as computing devices. Those skilled in the art will recognize that the database devices 320-324 can be incorporated into one or more of the servers 302-308 such that one or more of the servers 302-308 can include databases 320-324. In an exemplary embodiment, the system 100 can be implemented by the server 302. In some exemplary embodiments, the system 100 can be distributed over different servers 302-308. For example, the collector 102 can be implemented by the server 304, the engine 104 can be implemented by the server 306 and the engine 106 can be implemented by the server 308.

The client devices 310-314 can include a client side application 326-330 programmed and/or configured to access and/or interface with the system 100. In the present embodiment, the client devices 310-314 can be computing devices including, for example, portable computing devices. In some embodiments, the client-side application 326 implemented by the client device 310 can be a web-browser capable of navigating one or more web pages hosting GUIs 110 of the system 100. In some embodiments, the client-side applications 326-330 implemented by one or more of the client devices 310-314 (e.g., portable computing devices) can be applications specific to the system 100 to permit access to the system 100 or the applications 326-330 can be the system 100. In some embodiments, the application specific to the system 100 can be a mobile application installed and executed by a portable computing device. In exemplary embodiments, the client devices 310-314 can be configured to communicate with the network 350 via wired and/or wireless communication.

The databases 320-324 can store information for use by the system 100. For example, the database 320 can store information related to or generated by the collector 102, the database 322 can store information related to or generated by the engine 104, and the database 324 can store information related to or generated by the engine 106. In some exemplary embodiments, the databases 320-324 can store a combination of information related to or generated by the collector 102, the engine 104, and the engine 106.

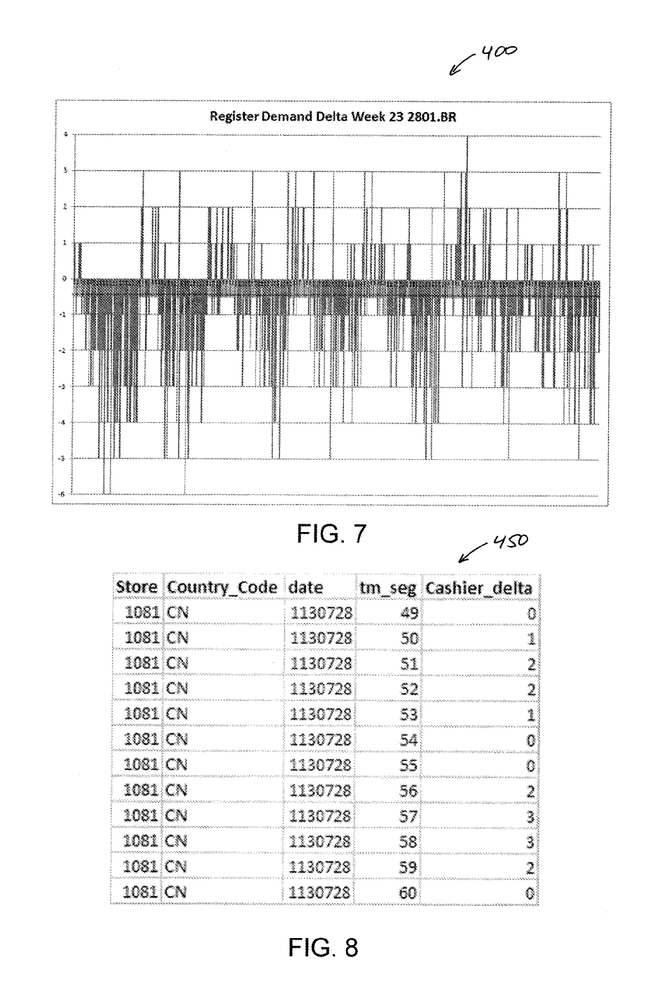

One or more graphical user interfaces can be included in some embodiments to facilitate user interaction with the performance evaluation system 100, the collector 102, the engine 104, the engine 106 and other features disclosed herein. With reference to FIG. 7, an exemplary graphical user interface window 400 (hereinafter “GUI window 400”) that can be rendered by the system 100 is provided. In particular, the GUI window 400 can provide a POS terminal or register demand chart with generated delta values for a period of time. For example, the GUI window 400 of FIG. 7 provides delta values for one store during week number 23 of the year and separated by fifteen minute time segments. As discussed above, delta values of zero indicate that the store was appropriately staffed for the time segment, positive delta values above zero indicate that the store was overstaffed for the time segment, and negative delta values below zero indicate that the store was understaffed for the time segment. Days or time segments, or both, of understaffing can thereby be depicted and the system 100 can adjust the understaffed time segments for a prospective scheduling period to ensure that the store is appropriately staffed in the future.

In some embodiments, adjustment of cashier scheduling with the system 100 can occur automatically on a recurring basis. For example, except for an input regarding the exception criteria, the system 100 can be automated to adjust cashier scheduling for a prospective period without input from an entity or a user. In some embodiments, an entity can designate which time periods should be adjusted based on the data depicted in the GUI window 400. In some embodiments, rather than indicating exception criteria, an entity or user can review graphical information provided by the system 100 and designates which time periods should be adjusted for prospective scheduling periods. Although the GUI window 400 is shown to provide data for only one week and one store, it should be understood that the system 100 can render the GUI window 400to display data for any desired period of time and/or for one or more stores.

With reference to FIG. 8, an exemplary graphical user interface window 450 (hereinafter “GUI window 450”) that can be rendered by the system 100 is provided. In particular, the GUI window 450 can provide a POS terminal or register demand table with generated delta values for a period of time. The GUI window 450 can include a table or chart with a store number, a country code, a date, a time segment, and a cashier delta value. For example, the GUI window 450 of FIG. 8 provides delta values for one store during time segments 49-60 which can correspond to predetermined fifteen minute time segments of a day. However, it should be understood that the GUI window 450 can show each time segment in minutes, e.g., 12:00 PM-12:15 PM. As discussed above, delta values of zero indicate that the store was appropriately staffed for the time segment, positive delta values indicate that the store was overstaffed for the time segment, and negative delta values indicate that the store was understaffed for the time segment. Thus, time segments 49, 54, 55 and 60 in FIG. 8 are shown to be appropriately staffed, time segments 50, 51, 52, 57, 58 and 59l are shown to be overstaffed, and time segments 53 and 56 are shown to be understaffed. Although the GUI window 450 is shown to provide data for only one date and one store, it should be understood that the system 100 can render the GUI window 400to display data for any desired period of time and/or for one or more stores.

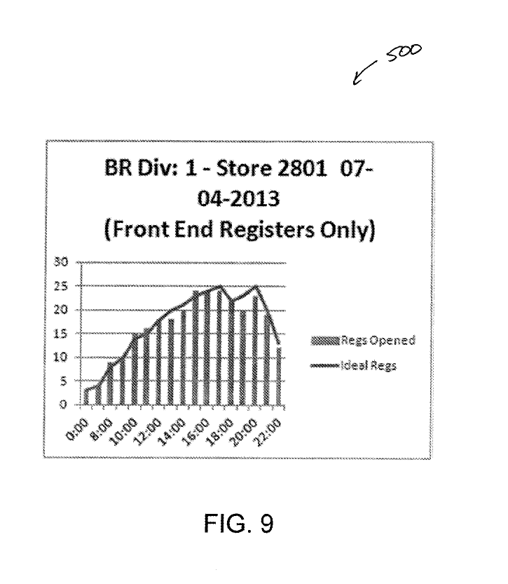

With reference to FIG. 9, an exemplary graphical user interface window 500 (hereinafter “GUI window 500 ”) that can be rendered by the system 100 is provided. In particular, the GUI window 500 can provide a POS terminal or register demand curve indicating understaffing and overstaffing at specific time segments for one day. For example, the bars in the demand curve can indicate the actual number of registers open, e.g., 20 registers at a time segment of 19:00, and the curve can indicate the target or ideal number of registers open, e.g., 23 registers at a time segment of 19:00. Although depicted as showing a demand curve for only one day, e.g., Jul. 4, 2013, in one store, it should be understood that the system 100 can render the GUI window 500 to display data for any desired period of time and/or for one or more stores. The visual displays provided by the GUI windows 400, 450, 500 can advantageously assist an entity in determining which periods of time are understaffed or overstaffed in one or more stores.

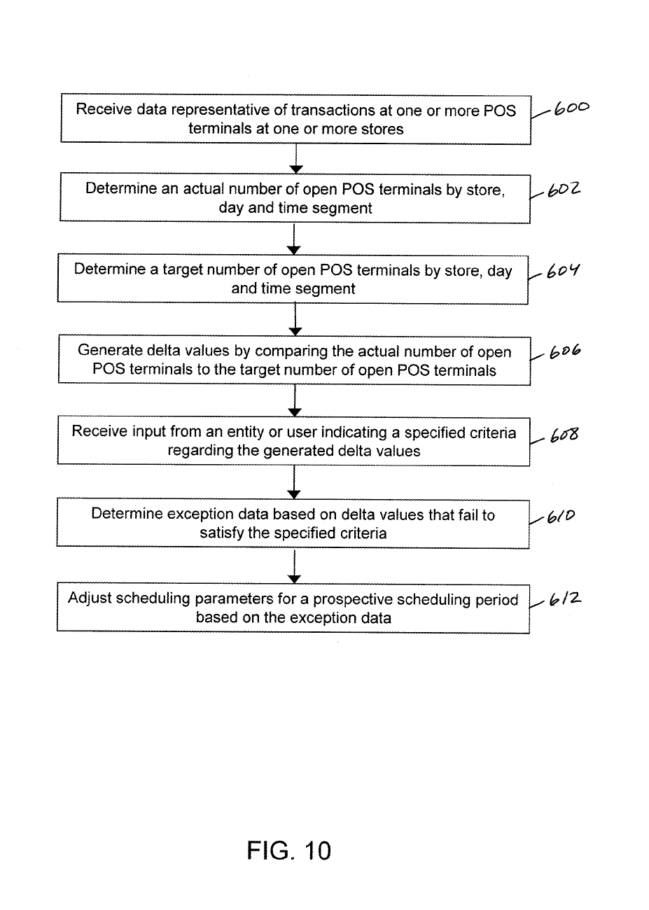

Turning to FIG. 10, a flowchart illustrating an exemplary method of a computer executable process carried out by the system 100 is provided. Data representative of transactions at one or more POS terminals (e.g., POS terminal data) at one or more stores can initially be programmatically collected or received by embodiments of the system 100 (step 600). For example, electronic data representative of past transactions at one or more POS terminals can be collected and stored in a database, and code can be programmatically executed to query the data representative of transactions at one or more POS terminals for a period of time. For example, code can be programmatically executed to query the data representative of transactions at one or more POS terminals to determine an actual number of POS terminals by store, day and time segment for a period of time (step 602). Code can be programmatically executed to determine a target number of open POS terminals by store, day and time segment for the period of time, thereby determining a target number of cashiers which should have been scheduled for the period of time by store, day and time segment (step 604).

Code can be programmatically executed to generate delta values by comparing the actual number of open POS terminals to the target number of open POS terminals by store, day and time segment (step 606). A user can specify, and input into the system 100, one or more specified criteria regarding the generated delta values (step 608). For example, the specified criteria can relate to a threshold number of consecutive negative delta values which indicate a frequency in understaffing for a particular day and time segment in a store. Although shown as occurring after step 606, it should be understood that step 608 can be performed any time before step 610, e.g., before or after steps 600, 602, 604 and 606.

Code can be programmatically executed to determine exception data based on the generated delta values that fail to satisfy the specified criteria (step 610). For example, if the specified criteria is indicated as four or less consecutive negative delta values and five consecutive negative delta values exist, the corresponding delta values can be flagged as exception data for failing to satisfy the specified criteria. In some embodiments, code can be programmatically executed to determine exception data based on the generated delta values that satisfy (rather than fail) the specified criteria. For example, if the specified criteria is indicated as four or more consecutive negative delta values and five consecutive negative delta values exist, the corresponding delta values can be flagged as exception data for satisfying the specified criteria. Code can be programmatically executed to adjust scheduling parameters, e.g., cashier or server scheduling, for a prospective scheduling period based on the exception data (step 612). For example, if the exception data and the negative delta values indicate that the store was understaffed by five cashiers during a particular day and time segment, code can be programmatically executed to adjust the cashier scheduling for a prospective period corresponding to the previous period for which delta values were determined such that the store can be appropriately staffed for the particular day and time segment in the future. Demand for servers or cashiers can thereby be accurately forecast based on previously collected data and server or cashier scheduling can be adjusted for one or more stores to ensure appropriate staffing during a prospective scheduling period.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A computer-implemented method of cashier scheduling for a store, comprising:
executing code to query a database for electronic data representative of transactions at a point-of-sale terminal in a store during a period of time;
programmatically comparing the electronic data representative of transactions at the point-of-sale terminal to target point-of-sale terminal data for the point-of-sale terminal in the store to generate delta values;
programmatically determining exception data based on the delta values, the exception data corresponding to the delta values that fail to satisfy a specified criteria, and
executing code to adjust scheduling parameters for a prospective scheduling period based on the exception data.

2. The computer-implemented method according to claim 1, wherein the electronic data representative of transactions at the point-of-sale terminal is determined by a queue theory algorithm.

3. The computer-implemented method according to claim 1, wherein the electronic data representative of transactions at the point-of-sale terminal is historical data.

4. The computer-implemented method according to claim 3, wherein the historical data is for a previous time segment of six weeks.

5. The computer-implemented method according to claim 1, wherein the electronic data representative of transactions at the point-of-sale terminal includes electronic data regarding an actual number of open registers and the target point-of-sale terminal data for the point-of-sale terminal includes electronic data regarding a target number of open registers.

6. The computer-implemented method according to claim 1, wherein programmatically comparing the electronic data representative of transactions at the point-of-sale terminal to the target point-of-sale terminal data for the point-of-sale terminal in the store to generate the delta values comprises subtracting electronic data representing a target number of open registers from electronic data representing an actual number of open registers.

7. The computer-implemented method according to claim 1, further comprising grouping the delta values by store, day, and time segment.

8. The computer-implemented method according to claim 7, wherein the time segment is a fifteen minute time segment.

9. The computer-implemented method according to claim 1, further comprising determining whether the delta values are positive or negative.

10. The computer-implemented method according to claim 1, wherein the specified criteria comprises a predetermined value that is a negative delta value threshold for a predetermined number of at least one of day segments or time segments.

11. The computer-implemented method according to claim 1, further comprising adjusting the exception data to account for transaction variables.

12. The computer-implemented method according to claim 1, comprising excluding a desired time segment from the period of time.

13. A non-transitory computer-readable medium storing instructions, wherein execution of the instructions by a processing device causes the processing device to implement a method of cashier scheduling for a store, comprising:
executing code to query a database for electronic data representative of transactions at a point-of-sale terminal in a store during a period of time;
programmatically comparing the electronic data representative of transactions at the point-of-sale terminal to target point-of-sale terminal data for the point-of-sale terminal in the store to generate delta values;
programmatically determining exception data based on the delta values, the exception data corresponding to the delta values that fail to satisfy a specified criteria; and
executing code to adjust scheduling parameters for a prospective scheduling period based on the exception data.

14. The medium according to claim 13, comprising grouping the delta values by store, day, and time segment.

15. A scheduling system for scheduling cashiers in a store, comprising:
a computer storage device storing electronic data representative of transactions at a point-of-sale terminal in a store, and
a processing device programmable to (i) execute code to query the computer storage device for the electronic data representative of transactions at the point-of-sale terminal in the store during a period of time, (ii) programmatically compare the electronic data representative of transactions at the point-of-sale terminal to target point-of-sale terminal data for the point-of-sale terminal in the store to generate delta values, (iii) programmatically determine exception data based on the delta values, the exception data corresponding to the delta values that fail to satisfy a specified criteria, and (iv) execute code to adjust scheduling parameters for a prospective scheduling period based on the exception data.

16. The system according to claim 15, wherein the electronic data representative of transactions at the point-of-sale terminal is determined by a queue theory algorithm.

17. The system according to claim 15, wherein the electronic data representative of transactions at the point-of-sale terminal includes electronic data regarding an actual number of open registers and the target point-of-sale terminal data for the point-of-sale terminal includes electronic data regarding a target number of open registers.

18. The system according to claim 15, wherein the processing device is programmable to programmatically compare the electronic data representative of transactions at the point-of-sale terminal to the target point-of-sale terminal data for the point-of-sale terminal in the store to generate the delta values by subtracting electronic data regarding a target number of open registers from electronic data regarding an actual number of open registers.

19. The system according to claim 15, wherein the processing device is programmable to group the delta values by store, day, and time segment.

20. The system according to claim 15, wherein the processing device is programmable to adjust the exception data to account for transaction variables.
